(19) United States
(12) Patent Application Publication
(10) Pub. No.: US 2008/0129540 A1
(43) Pub. Date: Jun. 5, 2008

(54) System, method and device for communicating information external to a vehicle

(76) Inventor: Jamaal Williams, Montgomery, LA (US)

Correspondence Address: JAMES RAY & ASSOCIATES, 2640 PITCAIRN ROAD, MONROEVILLE, PA, 15146, US

(21) Appl. No.: 11/983,891

(22) Filed: Nov. 13, 2007

Related U.S. Application Data
(60) Provisional application No. 60/865,921, filed on Nov. 15, 2006.

(51) Int. Cl. G08G 1/00

(52) U.S. Cl. 340/901

(57) ABSTRACT

A digital display system for communicating text and graphical information external to a vehicle includes a display assembly which is connected to a first source of electrical power capable of operating the display assembly. A control assembly is integrally mounted within a periphery of a sun visor body and connected to a second source of electrical, the control assembly having a processor, an input module, and a user control device operable by a user for transferring the at least one of a text and a graphical data through the input module through the processor to the display driver module. Physical wire connection or combination of wireless receiver and transmitter is employed for connecting the control assembly with the display assembly and for communicating the at least one of text and graphical data to be displayed by the display assembly when initiated by the user using the user control devices.

### CROSS-REFERENCE TO RELATED APPLICATIONS

This application is related to and claims priority from U.S. Provisional Patent Application Ser. No. 60/865,921 filed on Nov. 15, 2006.

### FIELD OF THE INVENTION

The present invention relates, in general, to vehicle digital displays and, more particularly, this invention relates to a digital display system installed on a vehicle for communicating text and graphical information to members of the general public, for example such other drivers and pedestrians.

### BACKGROUND OF THE INVENTION

As is generally well known, many invest considerable amount of time and money to personalize their vehicles. The personalization effort includes wheel spinners, elaborate paint design, high end stereo system, logos and the like. Of a particular importance is an area surrounding the license plate tag. Prior to the design and conception of the present invention, efforts have been made to provide digital display in combination with the license plate tag for the purpose of communicating text and graphic information to the members of general public and, particularly other drivers and pedestrians. U.S. Pat. No. 5,905,434 issued to Steffan et al, U.S. Pat. No. 5,105,179 issued to Smith, U.S. Pat. No. 6,641,038 issued to Gehlot et al, U.S. Pat. No. 7,142,104 issued to Blueford, U.S. Pub. No. 2005/0192744 to Magui et al and U.S. Pub. No. 2003/0142044 to Berry disclose various types of internally and externally mounted digital displays and control devices to operate such displays.

However, the need remains for a digital display system installed on a vehicle for communicating text and graphical information to other drivers and pedestrians.

### SUMMARY OF THE INVENTION

According to one embodiment, the invention provides, in combination with a vehicle, a system for communicating text and graphical information external to the vehicle. The system includes a display assembly which is connected to a first source for supplying an electrical power capable of operating the display assembly. A control assembly is integrally mounted within a periphery of a sun visor body and is connected to a second source for supplying the electrical power. The control assembly has a processor, an input module coupled to the processor, and a user control means operable by a user for transferring the at least one of a text and a graphical data through the input module to the processor and further to the display driver module. A communication means connect the control assembly and the display assembly for communicating the at least one of text and graphical data to be displayed by the display assembly when initiated by the user using the user control means.

According to another embodiment of the invention, there is provided a method of communicating text and graphical information external to the vehicle. The method includes the step of mounting at least one display assembly to a predetermined exterior or interior portion of a vehicle. Then, integrally mounting a control assembly within a periphery of a sun visor body of the vehicle. Next, receiving, at the control assembly, at least one of a text and graphical data. Then, sending, from the control assembly, the at least one of text and graphical data. Receiving, at the at least one display assembly, the at least one of sent text and graphical data. Finally, displaying, on a display provided within the at least one display assembly, image corresponding to the least one of received text and graphical data.

According to a further embodiment, the invention provides a sun visor assembly for a vehicle. The sun visor assembly includes a body portion. A hollow elongated member is connected to the body portion and has one end adapted for connecting the body portion to a mounting bracket fitted to a ceiling of a cabin of such vehicle. A control assembly is integrated into the body portion. The control assembly has means for receiving at least one of a text and a graphical data and sending the at least one of text and graphical data to at least one digital display assembly attached to interior or exterior portion of such vehicle. A communication means at least partially disposed within the sun visor assembly for operably connecting the control assembly with the at least one display assembly and for transmitting the at least one of text and graphical data thereto.

### OBJECTS OF THE INVENTION

It is, therefore, one of the primary objects of the present invention to provide a digital display system for a vehicle.

Another object of the present invention is to provide a digital display system that is capable of communicating text and graphical information to other drivers and pedestrians.

Yet another object of the present invention is to provide a digital display system that includes control assembly which is integrated into a sun visor.

A further object of the present invention is to provide a digital display system that can be simply and economically retrofitted on vehicles presently in use.

Yet a further object of the present invention is to provide a digital display system that can be installed without use of special tools.

An additional object of the present invention is to provide a method of communicating text and graphical information to members of general public using the above described system.

Another object of the present invention is to provide a novel sun visor incorporating a control assembly capable of displaying text and graphical information on at least one display.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a schematic diagram of a vehicle display system of the present invention;

FIG. 2 is a partial perspective view of the vehicle display system of the present invention, particularly illustrating control assembly incorporated integral within a sun visor body;

FIG. 3 is a perspective view of a novel sun visor incorporating the control assembly of the present invention;

FIG. 4a-4b depict end views of the sun visor of the present invention shown in various positions within the vehicle's cabin;

FIG. 5 is a perspective view of the vehicle display system of FIG. 1, particularly illustrating display assembly mounted to the front exterior portion of the vehicle in place of the license plate tag;

FIG. 6 is an end view of the display assembly of the present invention, particularly illustrating mounting means therefore.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a vehicle, includes but is not limited to car, van, truck and the like.

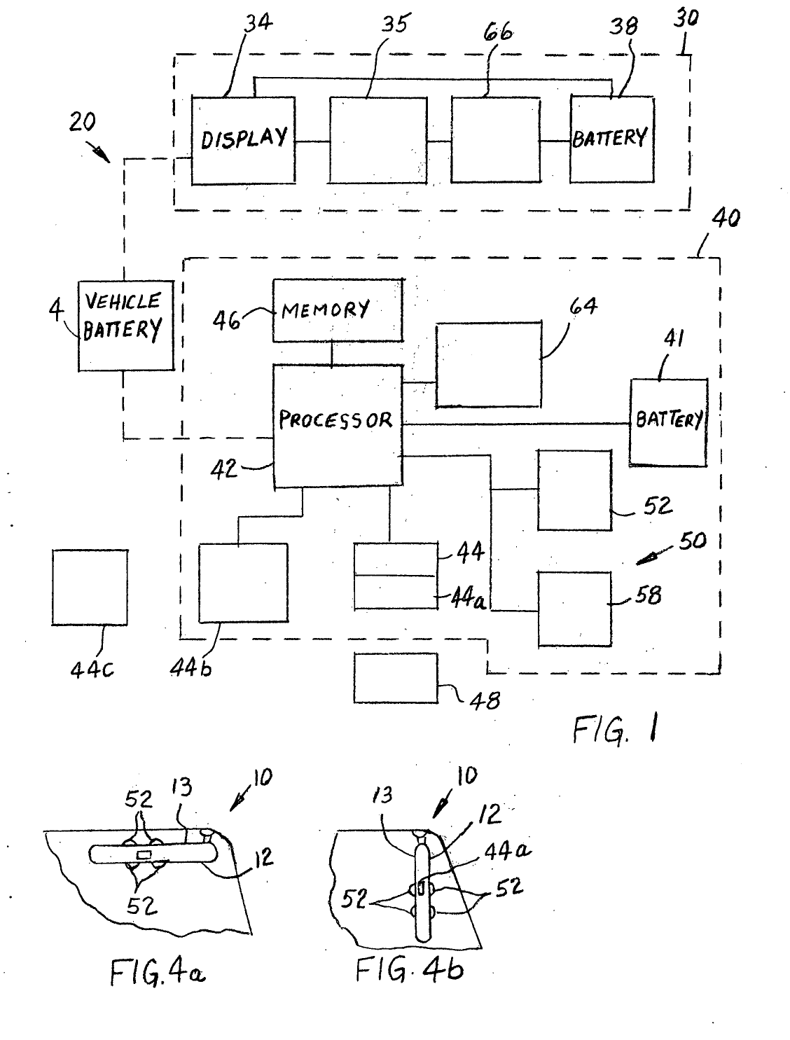

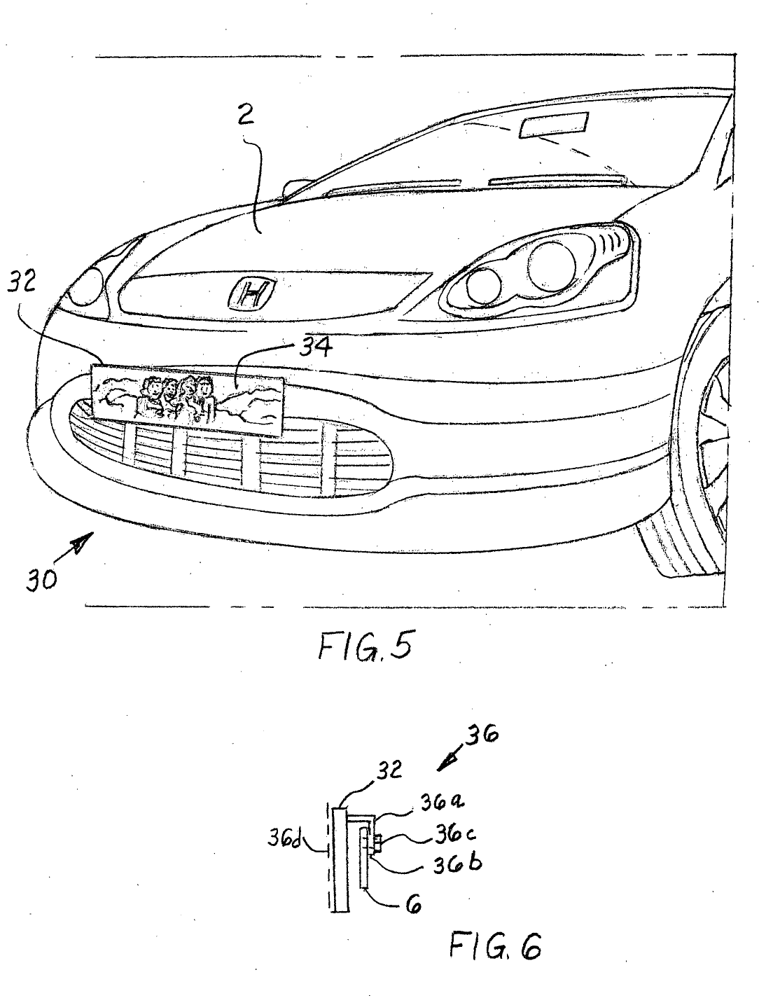

Reference is now made, to FIGS. 1-6, wherein there is shown a system, generally designated as 20, which is installed on a vehicle 2 for communicating text and graphical information to members of general public, such as other drivers, pedestrians, public officials and the like.

The system 20 includes a display assembly 30 which has a housing frame 32, a display 34 and a display driver module 35 which are mounted within the housing frame 32 and a mounting means 36 for mounting, preferably detachably, the display assembly 30 to a predetermined exterior or interior portion of the vehicle 2 so as to operably position the display 34 for viewing purposes. The display 34 may be of any well known digital display types and preferably is a liquid-crystal display. In a conventional manner, the display assembly 30 is provided as a single piece member. Preferably, the housing 32 and the screen of the display 34 are manufactured from a heat resistant polycarbonate material. Furthermore, it is preferred to coat the screen with conventional anti glare material for viewing the displayed information during sunlight conditions as well as being able to view the information during nightfall or darkness.

The display assembly 30 is either directly or indirectly connected to a source for supplying an electrical power capable of operating the display assembly 30. According to one embodiment of the invention, such source of electrical power is a battery 4 of the vehicle 2. According to another embodiment of the invention, a battery 38, either of a rechargeable or a non-rechargeable type, may be integrated into the display assembly 30.

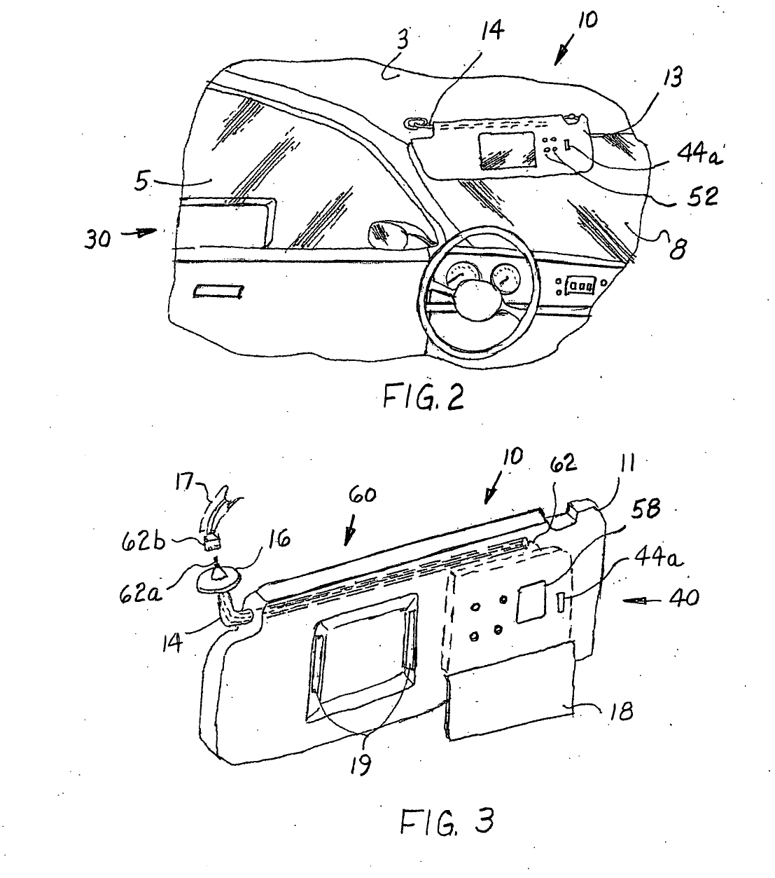

In accordance with a presently preferred embodiment of the invention, the display assembly 30 is attached to a bracket 6 generally employed for attachment of license plate tag (not shown) thereto, as best shown in FIG. 5. Accordingly, the mounting means 36 may be at least one simple bracket 36a having an aperture 36b aligned with a threaded aperture within the bracket 6 for attaching the display assembly 30 with threaded fasteners 36c. It is also within the scope of the present invention to adapt the mounting means 36 according to the construction of the license plate tag mounting arrangement. The display assembly 30 may be sized similar to the size of the license plate tag (not shown). It is also within the scope of the present invention to mount the display assembly 30 to a window, illustrated by way of an example only in FIG. 2 as a side window 5, by providing the mounting means 36 in a form of an adhesive tape 36d applied to the front surface of the frame 32.

The system 20 further includes a control assembly 40 which is integrally mounted within a sun visor assembly, generally designated as 10. Specifically, the control assembly 40 is integrated into a periphery of a sun visor body 11 having a pair of exterior surfaces 12 and 13. The sun visor body 11 is rotatably connected to an elongated member 14 which has one end thereof adapted for rotatable connection to a sun visor bracket 16 fitted to a cabin ceiling 3 of the vehicle 2. For the reasons to be explained later, the elongated member 14 may be formed as a hollow elongated member 14, for example from a tubular material. The control assembly 40 is also either directly or indirectly connected to the source of electrical power, for example such as the vehicle battery 4 or a dedicated battery 41.

The control assembly 40 includes a processor module 42. An input module 44 is coupled to the processor module 42. The processor 42, input module 44 or combination thereof is capable of performing function of a conventional digital media compact flash player. In accordance with a presently preferred embodiment of the invention, the input module 44 includes a receptacle 44a capable of receiving a nonvolatile data storage device 48 containing at least one of text and graphic data. The nonvolatile data storage device 48 is one of a flash drive and a flash memory card. Employment of such nonvolatile data storage device 48 is disclosed, for example, in U.S. Pub. No. 2003/0142044 and its disclosure is incorporated into this document by reference thereto. Alternatively or combination with the receptacle 44a, the input module 44 may include a wireless receiver means 44b for receiving the at least one of text and graphic data by way of a transmission from a remote location 44c. Such transmission may be either of a wireless or a satellite type.

An optional memory 46 may be coupled to the processor module 42 for storing a plurality of text and a graphical data received from the input module 44. A user control means 50 may be provided and operable by a user for transferring at least one of text and graphical data through the input module 44 to the processor module 42.

The present invention contemplates that the receptacle 44a and the user control means 50 are accessible from either one of the exterior surfaces 12, 13 of the sun visor body 11 depending on user's preference or frequency of changing the graphical or text information to be displayed on the display 34. Thus, the receptacle 44a and the user control means 50 may be hidden from direct view of the user when the sun visor body 11 is positioned in a non-operable position, as best shown in FIG. 4a, with a surface 13 coplanar to the surface of the cabin ceiling 3. Then, to access the receptacle 44a and/or the user control means 50, the user simply rotates the sun visor body 11 downwardly into a generally operable position, best shown in FIG. 4b, such as the position for shielding the user's eyes from direct sun light. Or, the receptacle 44a and the user control means 50 may be exposed to and directly viewed by the user when the sun visor body 11 is positioned in such non-operable position. It is further within the scope of the present invention to provide two sets of the user control means 50 for access thereto from each surface 12 or 13. By way of an example only, the user who is tasked to frequently select a unique text or graphical data to be displayed on the display 34 depending on the geographical location may prefer to have the user control means 50 exposed at all times thus eliminating the need to rotate the sun visor body 11 in order to access such user control means 50.

If required, at least one cover 18 may be pivotally attached to the sun visor body 11 for selectively covering and uncovering the receptacle 44a and/or the control user control means 50.

Finally, a communication means, generally designated as 60, is provided for connecting the control assembly 40 and the display assembly 30 and for communicating the at least one of text and graphic information to be displayed by the display assembly 30 when initiated by the user using the user control means 50.

According to one embodiment of the invention, the communication means 60 is at least one elongated wire 62, for example such as a video coax cable, capable of carrying the at least one of text and graphical data. Such at least one elongated wire 62 extends through the hollow elongated member 14 into the sun visor bracket 16. The at least one elongated wire 62 may be further routed through a structure of the vehicle 2, for example a conduit 17 or any other means, to the display assembly 30 and, if required, to the battery 4.

Alternatively, the communication means 60 may include a wireless transmitter 64 coupled to the control assembly 40 and integrally mounted within the periphery of the sun visor body 11 and a wireless receiver 66 mounted within the housing 32 of the display assembly 30 and operably coupled to the display driver module 35. The use of the wirelesses transmitter 64 and receiver 66 eliminates the need of physically connecting the control assembly 40 with the display assembly 30. Thus, the control assembly 40 may be only connected to the battery 4 of the vehicle 2 advantageously employing the vehicle wires which are currently provided for illuminating a conventional sun visor light 19. Thus, the control assembly 40 will be adapted for connection directly to the light powering wires or the protruding end of the at least one elongated wire 62 may be terminated with a male connector 62a for electrical coupling to the female connector 62b as disclosed in U.S. Pat. No. 6,676,129 issued to Wilson, whose disclosure is incorporated into this document by reference thereto. It will be appreciated that when the control assembly 40 is provided with its own battery 41, there is no need to electrically connect the control assembly 40 external the sun visor body 11.

The system 20 of the present invention is advantageous for use as both original installation on a new vehicle and retrofit on vehicles already in use. Particularly, for retrofit of the existing vehicle 2, the user first selects a portion, either internally or externally, and mounts the display assembly 30 to such portion. As was described above, the bracket 6 employed for attaching license plate tag (not shown), particularly adjacent the front bumper of the vehicle 2 is advantageous for mounting the display assembly 30. Then, the user removes the existing sun visor (not shown) and mounts a new sun visor assembly 10 having control assembly 40 integrally mounted therein to the sun visor bracket 16. When the communication means 60 is at least one physical wire 62, the user routs it through the conduit 17 and connects it with the display assembly 30 in a conventional manner. It will be appreciated that if the system 20 does not employ the independent battery sources 38, 41 to power the display assembly 30 or the control assembly 40, respectively, additional wires are provided to connect them to the battery 4 of the vehicle 2. Now, the user of the system 20 is capable of downloading graphic or text data either from the nonvolatile data storage device 48 or from the remote location 44c which is received at the control assembly 40 and, more particularly, received at the processor module 42 from the input module 44. Next, by using the user control means 50, the user sends such graphic or text data which is received at the display assembly 30 and which is converted by the display driver 35 and subsequently displayed on the display 34.

The use of the nonvolatile data storage device 48 enables the user to simply and easily download unique images and designs from any digital device, such as digital camera, mobile phone of mobile communication device, computer and the like, capable of generating such graphic or text data and saving it to nonvolatile data storage device 48. The images can be then displayed either as still, moving, or live action images or as video clips. Thus, the user is capable of personalizing and enhancing appearance of the vehicle 2.

The use of wireless receiver 44b and wireless transmittal of the graphical or text data from a remote location 44c eliminates the burden of procuring nonvolatile data storage device 48, storing the graphical or text data thereto and transporting such nonvolatile data storage device 48 to the vehicle 2.

The use of wireless receiver 44b also enables the system 20 to be simply and conveniently employed for the purpose of advertising and marketing purposes, particularly based on a specific geographical area. For example, one unique data will be transmitted when the vehicle 2 enters an area covered by a first preselected cell tower while another unique data will be transmitted when the vehicle 2 enters another area covered by a second preselected cell tower.

It will be appreciated that the user control means 50 will be configured depending on the actions to be performed by the user. For example, such user control means 50 may include a single switch 52 which will enable the user, by way of a single command signal, to receive graphical or text data at the control assembly 40, transmit it to the display assembly 30 and display it on the display 34. Or the user control means 50 may include a plurality of switches 52 and a viewer screen 58 for enabling the user to preview graphical or text data received at the control assembly 40 and select a specific message or image prior to sending it to the display assembly 30 either through the physical wire 62 or wirelessly, through the combination of the transmitter 64 and the receiver 66. The switches 52 may be of an electro-mechanical type, for example such as pushbutton switches, of a motion detection type or may be provided within the viewer screen 58 being of a touch screen type. It will be further appreciated that the user control means 50, the control assembly 40 and the communication means 60 may be adapted to control and operate a plurality of the display assemblies 30 either by providing pluralities of wires 62 or plurality of wireless transmitters 64 and/or wireless receivers 66 and accordingly configuring the user control means 50.

It is further within the scope of the present invention to combine, by way of a conventional layering method, the required license plate tag information such as number, state of issue and expiration date with the graphic or text data wherein the license plate tag information is presented as a still image on a front layer and the still or particularly moving graphical or text image is presented as a background layer. This may enable the display assembly 30 of the present invention to be installed in place of the rear license plate tag as well and meet requirements of those states that mandate use of the license plate tag both at the front and rear of the vehicle 2.

It has been found that integrating the control assembly 40 into the sun visor body 11 achieves unexpected benefits. First, the control assembly 40 may be conveniently hidden from direct view. Second, it does not obstruct direct view of the user or passengers of the vehicle 2 looking out through the windshield 8. Third, it is positioned in close proximity to the user of the vehicle 2 who can simply reach the sun visor body 11 and access the receptacle 44a and/or the user control means 50. Forth, when the connection between the control assembly 40 and the display assembly 30 is by way of the at least one wire 62, the sun visor assembly 10 having such control assembly 40 integrated thereinto provides for cost efficient routing of such at least one wire 62 through the structure of the vehicle 2 having sun visor light powering wires disposed therein thus eliminating structural modifications to the interior portion of the vehicle 2 and/or presence of exposed wires. Fifth, the installation of the sun visor assembly 10 having such control assembly 40 integrated thereinto is achieved without the need for special tools by the user having only a novice level in the electro-mechanical art.

Although, the display driver module 35 is illustrated as being integrated into the display assembly 30, it will be apparent to those skilled in the art that the display driver module 35 may be provided within the control assembly 40.

Furthermore, although the receptacle 44a is described as being accessible from the exterior surface 12, 13 it can be also accessible from and portion of the peripheral edge of the sun visor body 11, for example as best shown in FIGS. 4a-4b.

Additionally, it will be appreciated that the display assembly 30 or the control assembly 40 can be connected to the alternator or fuse box employed within the vehicle 2 for the purposes of using electrical power.

It is also within the scope of the present invention to attach the display assembly 30 to a roof or trunk cover (not shown) of the vehicle 2.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a vehicle a system for communicating text and graphical information external to said vehicle, said system comprising:
(a) a display assembly connected to a first source for supplying an electrical power capable of operating said display assembly;
(b) a control assembly integrally mounted within a periphery of a sun visor body and connected to a second source for supplying said electrical power, said control assembly having a processor, an input module coupled to said processor, and a user control means operable by a user for transferring said at least one of a text and a graphical data through said input module to said processor and further to said display driver module; and
(c) a communication means connecting said control assembly and said display assembly for communicating said at least one of text and graphical data to be displayed by said display assembly when initiated by the user using said user control means.

2. The apparatus, according to claim 1, wherein said predetermined exterior portion of said vehicle is suitable for receiving a license plate tag.

3. The system, according to claim 1, wherein said display assembly includes:
(a) a housing frame;
(b) a display mounted within said housing frame;
(c) a display driver module coupled to said display, and
(d) a mounting means disposed on and secured to said frame for detachably mounting said display assembly to a predetermined exterior or interior portion of said vehicle.

4. The apparatus, according to claim 3, wherein said display is a liquid-crystal display.

5. The system, according to claim 1, wherein said display assembly includes said first source of electrical power.

6. The system, according to claim 5, wherein said first source of electrical power is a battery disposed within said display assembly.

7. The system, according to claim 1, wherein said input module includes a receptacle capable of receiving a nonvolatile data storage device containing said at least one of text and graphical data.

8. The system, according to claim 7, wherein said nonvolatile data storage device is one of a flash drive and a flash memory card.

9. The system, according to claim 1, wherein said input module includes a wireless receiver means for receiving said at least one of text and graphical data by way of a transmission from a remote location.

10. The system, according to claim 9, wherein said transmission is one of a wireless and a satellite.

11. The system, according to claim 1, wherein said communication means is at least one elongated wire capable of carrying said at least one of text and graphical data.

12. The system, according to claim 1, wherein said communication means includes a wireless transmitter coupled to said control assembly and integrally mounted within said periphery of said sun visor body and a wireless receiver mounted within said display assembly.

13. A method of communicating text and graphical information external to a vehicle, said method comprising the steps of:
(a) mounting at least one display assembly to a predetermined interior or exterior portion of said vehicle;
(b) integrally mounting a control assembly within a periphery of a sun visor body of said vehicle;
(c) receiving, at said control assembly, at least one of a text and graphical data;
(d) sending, from said control assembly, said at least one of text and graphical data;
(e) receiving, at said at least one display assembly, said at least one of text and graphical data sent in step (d); and
(f) displaying, on a display provided within said at least one display assembly, image corresponding to said least one of text and graphical data received in step (e).

14. The method, according to claim 13, wherein said sending step includes the step of providing a wireless transmitter within said control assembly, the step of providing wireless receiver within said display assembly and the step of transmitting said at least one of text and graphical data in a wireless manner.

15. The method, according to claim 13, wherein said control panel mounting step includes the step of mounting said sun visor to a sun visor mounting bracket provided within said vehicle, and the step of connecting said control assembly with said display assembly with at least one wire routed through a structure of said vehicle.

16. The method, according to claim 13, wherein said step of receiving said at least one of text and graphical data at said control assembly includes the step of connecting a nonvolatile data storage device to a receptacle disposed within said control assembly.

17. The method, according to claim 13, wherein said method includes the additional step of connecting each of said display assembly and said control panel to a source of electrical power.

18. A sun visor assembly for a vehicle, said sun visor assembly comprising:
(a) a body portion;
(b) a hollow elongated member connected to said body portion and having one end configured for connecting said body portion to a mounting bracket fitted to a ceiling of a cabin of such vehicle;
(c) a control assembly integrated into said body portion, said control assembly having means for receiving at least one of a text and a graphical data and sending said at least one of text and graphical data to at least one digital display assembly attached to interior or exterior portion of such vehicle; and
(d) a communication means at least partially disposed within said sun visor assembly for operably connecting said control assembly with said at least one display assembly and for transmitting said at least one of text and graphical data thereto.

19. The sun visor assembly, according to claim 18, wherein said receiving means includes an input module and a receptacle which is accessible from an exterior surface or peripheral edge of said body portion for operably receiving a nonvolatile data storage device.

20. The sun visor assembly, according to claim 18, wherein said control assembly includes a user control means operable from exterior surface or peripheral edge of said body portion for at least initiating transmittal of said at least one of text and graphical data to said at least one display assembly.
